(19) United States
(12) Patent Application Publication
(10) Pub. No.: US 2002/0168901 A1
(43) Pub. Date: Nov. 14, 2002

(54) Genderless, high current electrical connector with auxiliary contacts

(76) Inventor: Azeddine Choumach, Brighton, MA (US)

Correspondence Address: Richard J. Birch, P.O. Box 1818, New London, NH, 03257, US

(21) Appl. No.: 09/828,711

(22) Filed: Apr. 7, 2001

Related U.S. Application Data
(60) Provisional application No. 60/196,019, filed on Apr. 7, 2000.

(51) Int. Cl. H01R 25/00

(52) U.S. Cl. 439/638

(57) ABSTRACT

A genderless, high current electrical connector having main electrical contacts and auxiliary electrical contacts for control, signaling, data and similar functions including make first/break last or make last/break first contacts with housing polarization configurations for varying voltages.

### REFERENCE TO PROVISIONAL APPLICATION

Provisional Application of Azeddine (n) Choumach for Genderless, high current electrical connector with auxiliary contacts filed Apr. 7, 2000 as Serial No. 60/196,019.

### BACKGROUND OF THE INVENTION

The present invention relates to genderless, high current electrical connectors in general, and more particularly, to high current electrical connectors having main, high current electrical contacts and auxiliary electrical contacts for providing a variety of electrical functions associated with the main contacts.

The battery motive, material handling industry typically employs battery charging stations to charge and “swap” battery packs for the material handling vehicles. This is a time consuming operation that significantly reduces the effective operating time of the vehicle. Recently, the concept of “fast” charging the vehicle's battery pack on the vehicle itself has gained acceptance in the material handling industry. Such “fast” charging involves high charging currents. Mating electrical connectors are utilized in transferring the charging electrical current from the electrical current source to the vehicle's battery pack.

### SUMMARY OF THE INVENTION

A genderless electrical connector has high current electrical contacts that mate with a corresponding electrical connector to provide a connection for charging current to a battery pack such as, that utilized on a material handling vehicle. Auxiliary electrical contacts are provided in the electrical connector for control, signaling, data and similar functions including make first/break last or vice versa contacts. Polarization configurations preferably are included in the connector housing.

### DESCRIPTION OF THE DRAWINGS

FIG. 1 is a perspective view of mating genderless electrical connectors with main electrical contacts and auxiliary contacts;

FIG. 2A is a view in perspective of the front face of one of the electrical connectors shown in FIG. 1;

FIG. 2B is a view in perspective of the back side of the connector shown in FIG. 2A;

FIGS. 3A through 3D are outline drawings of one of the genderless electrical connectors shown in FIG. 1 with FIG. 3A illustrating the front face of the connector, FIG. 3B the bottom of the connector, FIG. 3C a side view of the connector, and FIG. 3D the top of the connector.

### DETAILED DESCRIPTION OF THE INVENTION

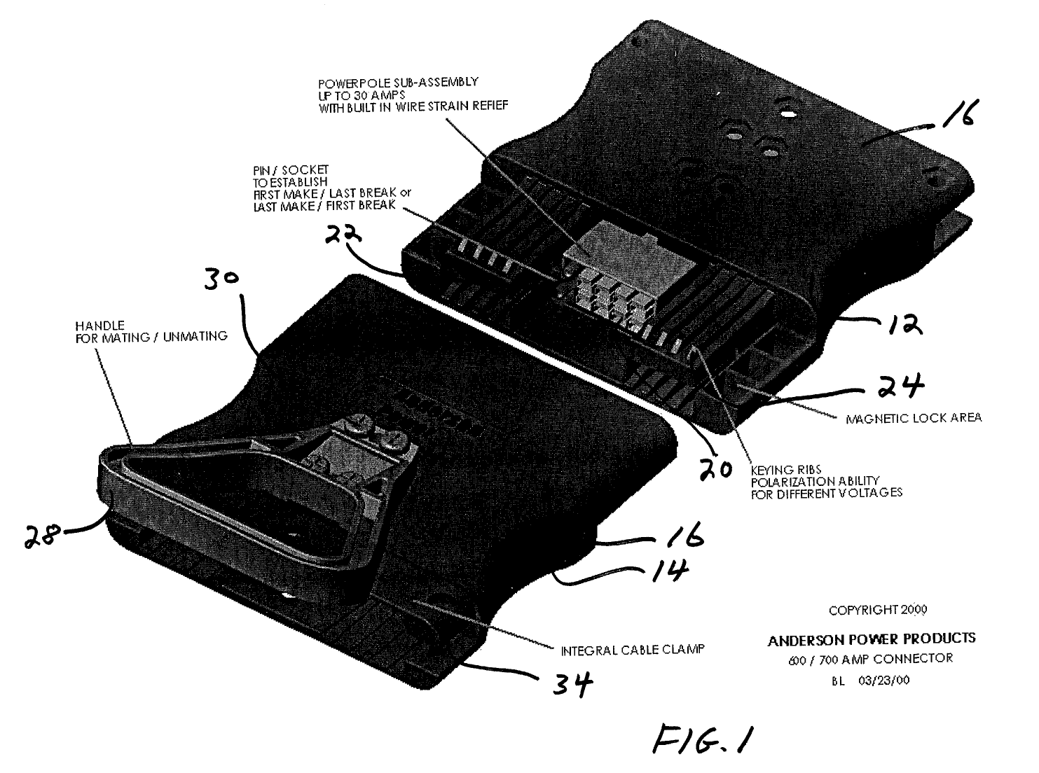

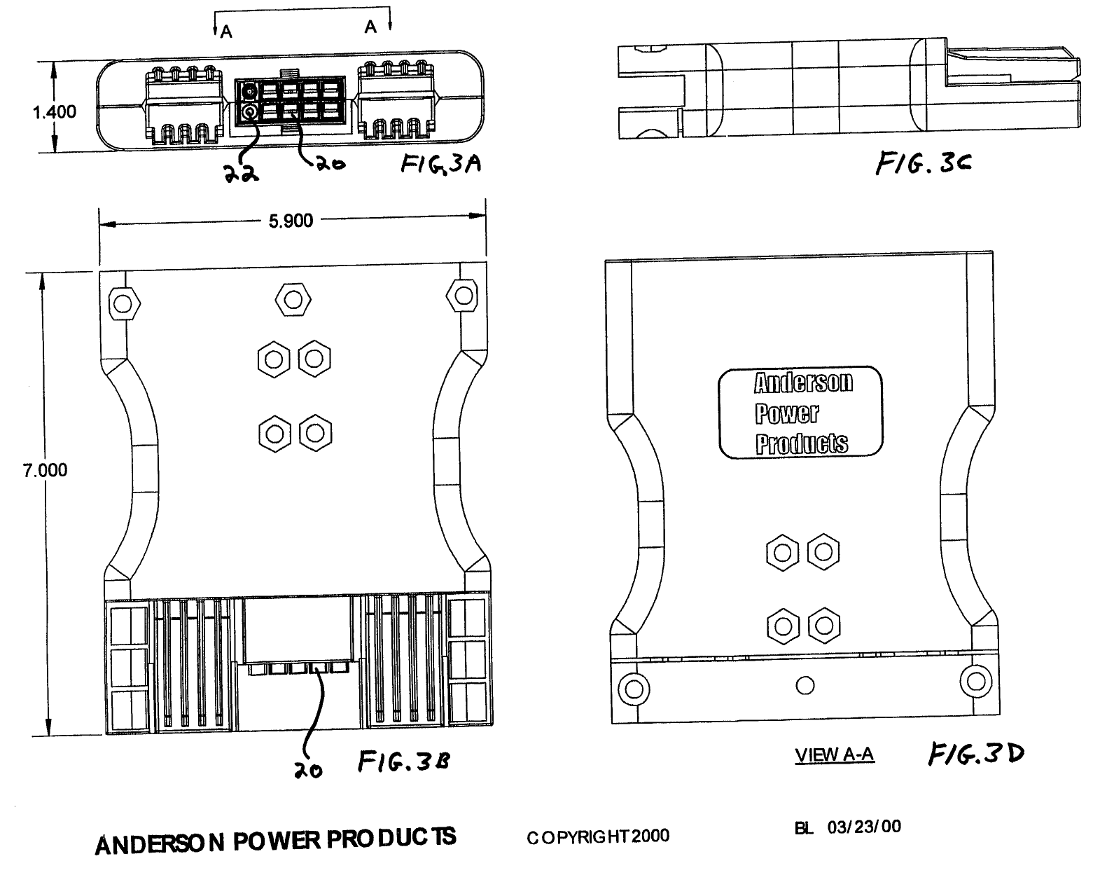

Referring to FIG. 1, the genderless electrical connector is identified generally reference numeral 10 and depicts two such connector as 12 and 14. Using the connector 12 as an example of connector 10, it has a housing 16 with two high current electrical contacts 18 mounted with the housing. Such two part (see FIGS. 3A-3D) housings are sold by Anderson Interconnect, Inc, under the Registered Trademarks “SB” and SBX”. Typically, the contacts 18 are capable of handling currents in the order of 600-700 amps at varying voltages in the range of 6-48 volts for “fast” battery charging, but can range up to 150 volts. The contacts can accommodate cables in the order of 300 MCM (two 3/0) for 600 amps and 400 MCM (two 4/0) for 700 amps or any combination thereof. The material handling industry is moving to the concept of “fast” charging in which the vehicle's battery bank is “fast” charged at high currents e.g. 600-700 amps for a relatively short period of time, such as, 15-30 minutes in order to avoid battery pack swapping during a normal work shift.

Auxiliary contacts 20 and 22 are also mounted within the housing 12. Auxiliary contacts 20 are depicted as genderless connectors sold by Anderson Interconnect, Inc. of Sterling, Mass. under the Registered Trademark “POWERPOLE”. The connectors are described in U.S. Pat. Nos. 3,218,599 and 3,259,870 which are incorporated herein by reference. Auxiliary contacts 22 are conventional pin and socket contacts that can be configured for a make first/break last or break first/make last electrical connection(s). It should be understood that the contacts 20 and 22 can be the same type i.e. all pin and socket or all POWERPOLE connectors or a combination thereof.

The housing 16 has a plurality of ribs 24 that can be configured in various orders and/or widths to provide a polarized connector for varying voltages. A magnetic lock or sensor 26 is mounted in housing 16 to provide an indication of engagement of the two connectors 12 and 14 for control/alarm etc. purposes.

Given the size of the contacts 18 and the disassembly force need to pull apart the mated connectors 12 and 14, preferably a handle 28 is attached to at least one of the connectors by means of fasteners 30 such as, bolts.

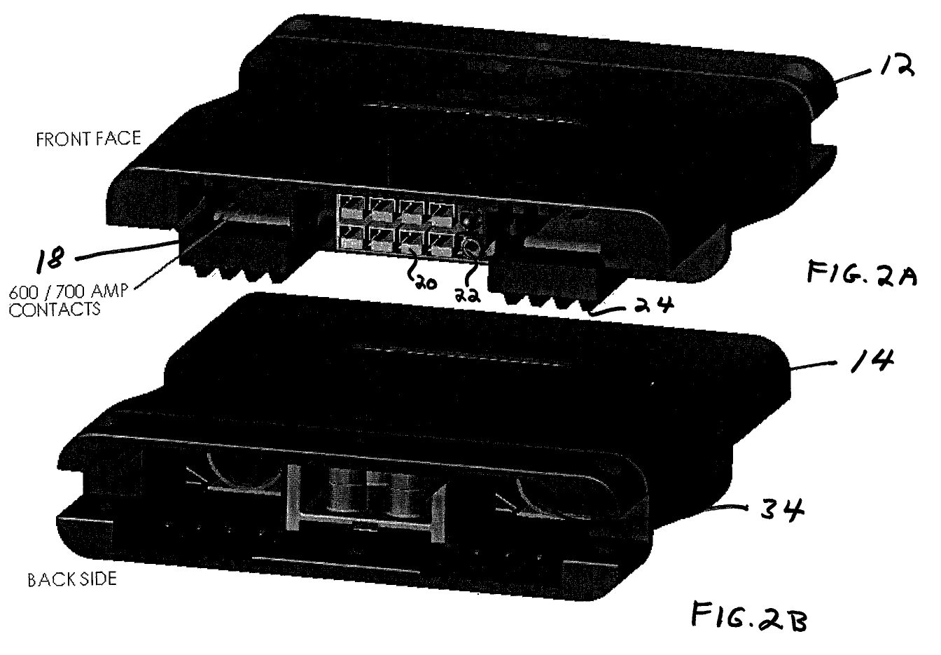

FIGS. 2A and 2B illustrate in slightly enlarged view one of the connectors shown in FIG. 1. The same reference numerals are used in FIGS. 2A and 2B as were used in FIG. 1 to identify the same components.

FIGS. 3A through 3B are outline drawings of one of the genderless connectors shown in FIG. 1. Again the same reference numerals are used to identify the same components. It should be understood that in FIG. 3B sockets 32 are illustrated which hold the magnetic lock or sensor 26 shown in FIG. 1.

In addition, the two part housing 16 can have an integral cable clamp 34 as shown in FIG. 1. It will be appreciated the fasteners for the two halves of housing 16 e.g., nuts ans bolts have been omitted from the drawings for purposes of simplicity of illustration.

Having described in detail the invention, it should be understood that numerous modifications can be made therein without departing from the scope of the invention as defined in the following claims.

What I claim is:

1. An electrical connector having:
(a) a housing
(b) at least two main genderless electrical contacts mounted therein, said at least two main electrical contacts conducting electrical currents in the range of 600-700 amps at voltages in the range of 6-48 volts and adapted to mate with corresponding genderless main electrical contacts in a corresponding housing; and,
(c) a plurality of auxiliary electrical contacts mounted within said housing and adapted to mate with corresponding auxiliary contacts mounted in a corresponding housing of an electrical connector.

2. The electrical connector of claim 1 wherein said plurality of auxiliary electrical contacts are genderless.

3. The electrical connector of claim 1 wherein said plurality of auxiliary electrical contacts are non-genderless.

4. The electrical connector of claim 1 wherein said auxiliary electrical contacts comprise a combination of genderless and non-genderless electrical contacts.

5. The electrical connector of claim 1 wherein at least one of said plurality of auxiliary contacts provides make first/break last electrical contact when mated to a corresponding electrical connector.

6. The electrical connector of claim 1 wherein at least one of said plurality of auxiliary contacts provides break first/make last electrical contact when mated to a corresponding electrical connector

7. The electrical connector of claim 1 wherein said housing has at least one mechanical polarizing element to permit mating only with a corresponding polarized housing of another electrical connector.

8. The electrical connector of claim 1 wherein said housing has an integrally formed electrical cable clamp.

9. The electrical connector of claim 1 wherein said housing includes a handle for use in separating thge electrical connector from a corresponding elecrtrical connector when the two connectors are physically mated.

10. The electrical connector of claim 1 wherein said housing includes a senor responsive to the engagement of the electrical connector with a corresponding electrical connector.

11. The electrical connector of claim 10 wherein said sensor is a magnet.

12. An electrical connector having:
(a) a housing
(b) at least two main genderless electrical contacts mounted therein, said at least two main electrical contacts conducting electrical currents in the range of 600-700 amps at voltages up to 150 volts and adapted to mate with corresponding genderless main electrical contacts in a corresponding housing; and,
(c) a plurality of auxiliary electrical contacts mounted within said housing and adapted to mate with corresponding auxiliary contacts mounted in a corresponding housing of an electrical connector.

13. The electrical connector of claim 12 wherein said plurality of auxiliary electrical contacts are genderless.

14. The electrical connector of claim 12 wherein said plurality of auxiliary electrical contacts are non-genderless.

15. The electrical connector of claim 12 wherein said auxiliary electrical contacts comprise a combination of genderless and non-genderless electrical contacts.

16. The electrical connector of claim 12 wherein at least one of said plurality of auxiliary contacts provides make first/break last electrical contact when mated to a corresponding electrical connector.

17. The electrical connector of claim 12 wherein at least one of said plurality of auxiliary contacts provides break first/make last electrical contact when mated to a corresponding electrical connector

18. The electrical connector of claim 12 wherein said housing has at least one mechanical polarizing element to permit mating only with a corresponding polarized housing of another electrical connector.

19. The electrical connector of claim 12 wherein said housing has an integrally formed electrical cable clamp.

20. The electrical connector of claim 12 wherein said housing includes a handle for use in separating thge electrical connector from a corresponding elecrtrical connector when the two connectors are physically mated.

21. The electrical connector of claim 12 wherein said housing includes a senor responsive to the engagement of the electrical connector with a corresponding electrical connector.

22. The electrical connector of claim 12 wherein said sensor is a magnet.
